(19) United States
(12) Patent Application Publication
(10) Pub. No.: US 2012/0033138 A1
(43) Pub. Date: Feb. 9, 2012

(54) MOTION DETECTOR FOR CADENCE AND SCENE CHANGE DETECTION AND METHODS FOR USE THEREWITH

(75) Inventors: Xinghai Li, North York (CA); Xu Gang Zhao, Maple (CA); Hongri Wang, Richmond Hill (CA)

(73) Assignee: VIXS SYSTEMS, INC., TORONTO (CA)

(21) Appl. No.: 12/851,042

(22) Filed: Aug. 5, 2010

(51) Int. Cl. H04N 5/14

(52) U.S. Cl. 348/700; 348/E05.067

(57) ABSTRACT

A motion identification signal is generated, based on a sequence of pictures of a video signal. A motion adaptive filter is adapted based on the motion identification signal. A scene change detection signal is generated based on the motion identification signal. A cadence detection signal can also be generated based on the motion identification signal.

### TECHNICAL FIELD OF THE INVENTION

The present invention relates to motion detectors and related methods used in devices such as video encoders and video display devices.

### DESCRIPTION OF RELATED ART

Video encoding has become an important issue for modern video processing devices. Robust encoding algorithms allow video signals to be transmitted with reduced bandwidth and stored in less memory. Standards have been promulgated for many encoding methods including the H.264 standard that is also referred to as MPEG-4, part 10 or Advanced Video Coding, (AVC).

Video filters such as noise filters or comb filters are frequently used before video encoding or display to improve picture quality or to enhance picture detail. Video filters can remove noise, reduce discolorations in picture detail, provide purer color and reduce or eliminate video artifacts such as dot crawl and rainbow swirls. These filters work well when a picture is stationary, however, motion in the video image can produce undesirable picture degradation. Therefore, these filters are usually motion-adaptive and a motion detection device is usually implemented with these filters.

Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of various video devices in accordance with embodiments of the present invention.

FIG. 4 presents a block diagram representation of a video device in accordance with an embodiment of the present invention.

FIG. 5 presents a block diagram representation of a video encoder/decoder 102 in accordance with an embodiment of the present invention.

FIG. 6 presents a block diagram representation of a filter module 222 in accordance with an embodiment of the present invention.

FIG. 7 presents a graphical representation of a pixel matrix from different pictures in accordance with an embodiment of the present invention.

FIG. 8 presents a block diagram representation of a video distribution system 375 in accordance with an embodiment of the present invention.

FIG. 9 presents a block diagram representation of a video storage system 179 in accordance with an embodiment of the present invention.

FIG. 10 presents a flowchart representation of a method in accordance with an embodiment of the present invention.

### DETAILED DESCRIPTION OF THE INVENTION INCLUDING THE PRESENTLY PREFERRED EMBODIMENTS

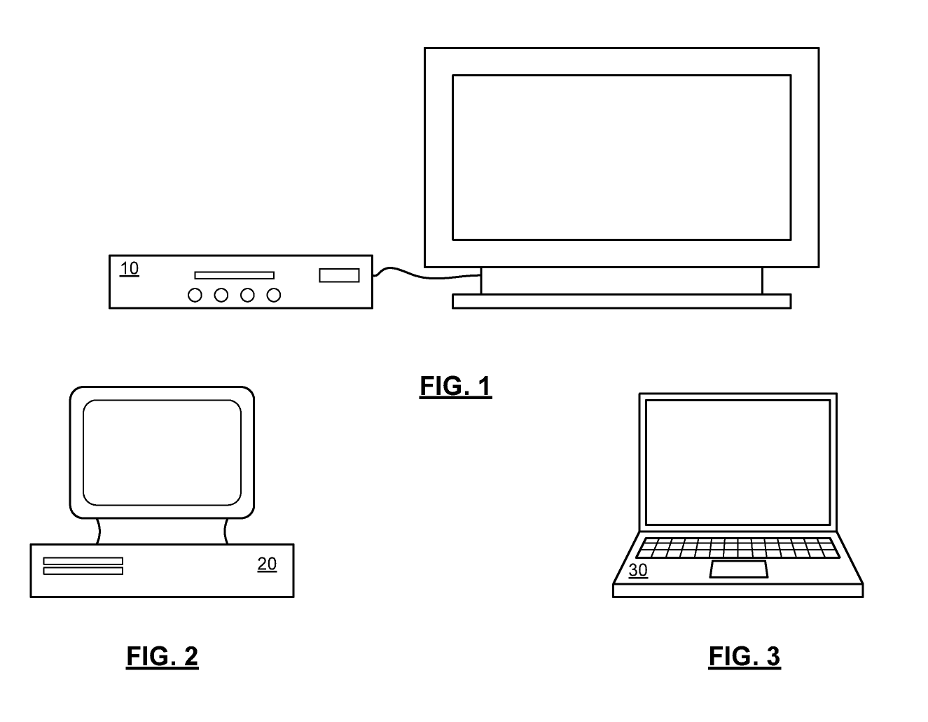

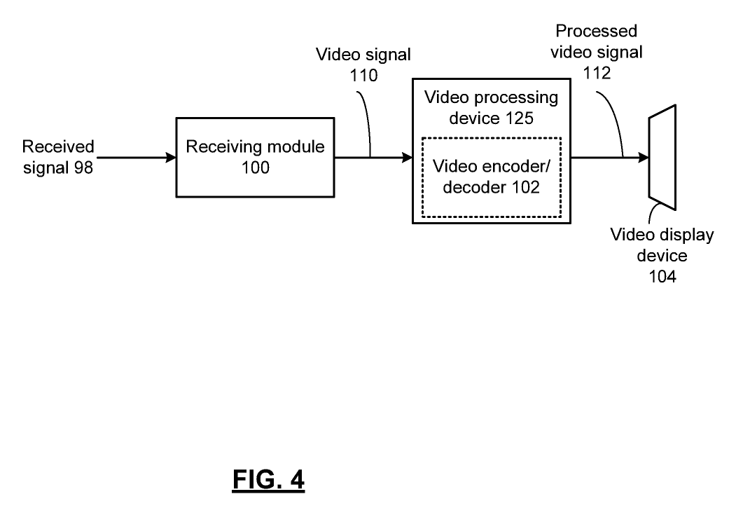

FIGS. 1-3 present pictorial diagram representations of various video devices in accordance with embodiments of the present invention. In particular, set top box 10 with built-in digital video recorder functionality or a stand alone digital video recorder, computer 20 and portable computer 30 illustrate electronic devices that incorporate a video device 125 that includes one or more features or functions of the present invention. While these particular devices are illustrated, video processing device 125 includes any device that is capable of encoding, decoding and/or transcoding video content in accordance with the methods and systems described in conjunction with FIGS. 4-10 and the appended claims.

FIG. 4 presents a block diagram representation of a video device in accordance with an embodiment of the present invention. In particular, this video device includes a receiving module 100, such as a television receiver, cable television receiver, satellite broadcast receiver, broadband modem, 3G transceiver or other information receiver or transceiver that is capable of receiving a received signal 98 and extracting one or more video signals 110 via time division demultiplexing, frequency division demultiplexing or other demultiplexing technique. Video processing device 125 includes video encoder/decoder 102 and is coupled to the receiving module 100 to encode, decode or transcode the video signal for storage, editing, and/or playback in a format corresponding to video display device 104.

In an embodiment of the present invention, the received signal 98 is a broadcast video signal, such as a television signal, high definition television signal, enhanced definition television signal or other broadcast video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include an analog video signal that is formatted in any of a number of video formats including National Television Systems Committee (NTSC), Phase Alternating Line (PAL) or Sequentiel Couleur Avec Memoire (SECAM) of other analog format. Processed video signal 112 can include a digital video signal complying with a digital video codec standard such as H.264, MPEG-4 Part 10 Advanced Video Coding (AVC) or another digital format such as a Motion Picture Experts Group (MPEG) format (such as MPEG1, MPEG2 or MPEG4), Quicktime format, Real Media format, Windows Media Video (WMV) or Audio Video Interleave (AVI), etc. Video signal 110 can, in the alternative, include a digital video signal—particularly when the encoder/decoder 102 operates to decode or transcode the video signal 110.

Video display devices 104 can include a television, monitor, computer, handheld device or other video display device that creates an optical image stream either directly or indirectly, such as by projection, based on decoding the processed video signal 112 either as a streaming video signal or by playback of a stored digital video file.

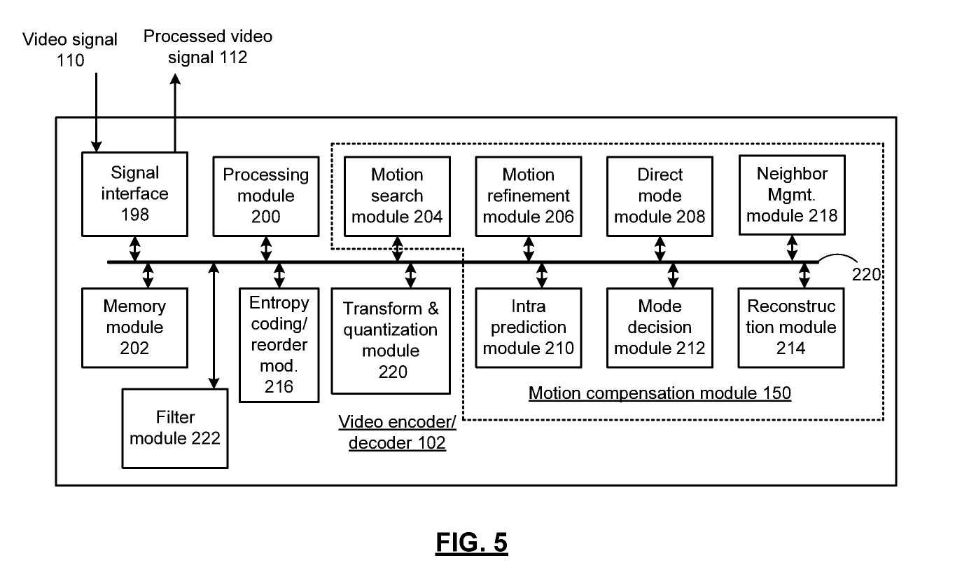

FIG. 5 presents a block diagram representation of a video encoder/decoder 102 in accordance with an embodiment of the present invention. In particular, video encoder/decoder 102 can be a video codec that operates in accordance with many of the functions and features of the H.264 standard, the MPEG-4 standard, VC-1 (SMPTE standard 421M) or other standard, to process processed video signal 112 to encode, decode or transcode video input signal 110. Video input signal 110 is optionally formatted by signal interface 198 for encoding, decoding or transcoding.

The video encoder/decoder 102 includes a processing module 200 that can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 200, and memory module 202 are coupled, via bus 221, to the signal interface 198 and a plurality of other modules, such as motion search module 204, motion refinement module 206, direct mode module 208, intra-prediction module 210, mode decision module 212, reconstruction module 214, entropy coding/reorder module 216, neighbor management module 218, forward transform and quantization module 220 and filter module 222. The modules of video encoder/decoder 102 can be implemented in software or firmware and be structured as operations performed by processing module 200. Alternatively, one or more of these modules can be implemented using a hardware engine that includes a state machine, analog circuitry, digital circuitry, and/or logic circuitry, and that operates either independently or under the control and/or direction of processing module 200 or one or more of the other modules, depending on the particular implementation. It should also be noted that the software implementations of the present invention can be stored on a tangible storage medium such as a magnetic or optical disk, read-only memory or random access memory and also be produced as an article of manufacture. While a particular bus architecture is shown, alternative architectures using direct connectivity between one or more modules and/or additional busses can likewise be implemented in accordance with the present invention.

Video encoder/decoder 102 can operate in various modes of operation that include an encoding mode and a decoding mode that is set by the value of a mode selection signal that may be a user defined parameter, user input, register value, memory value or other signal. In addition, in video encoder/decoder 102, the particular standard used by the encoding or decoding mode to encode or decode the input signal can be determined by a standard selection signal that also may be a user defined parameter, user input, register value, memory value or other signal. In an embodiment of the present invention, the operation of the encoding mode utilizes a plurality of modules that each perform a specific encoding function. The operation of decoding also utilizes at least one of these plurality of modules to perform a similar function in decoding. In this fashion, modules such as the motion refinement module 206 and more particularly an interpolation filter used therein, and intra-prediction module 210, can be used in both the encoding and decoding process to save on architectural real estate when video encoder/decoder 102 is implemented on an integrated circuit or to achieve other efficiencies. In addition, some or all of the components of the direct mode module 208, mode decision module 212, reconstruction module 214, transformation and quantization module 220, filter module 222 or other function specific modules can be used in both the encoding and decoding process for similar purposes.

Motion compensation module 150 includes a motion search module 204 that processes pictures from the video input signal 110 based on a segmentation into macroblocks of pixel values, such as of 16 pixels by 16 pixels size, from the columns and rows of a frame and/or field of the video input signal 110. In an embodiment of the present invention, the motion search module determines, for each macroblock or macroblock pair of a field and/or frame of the video signal one or more motion vectors that represents the displacement of the macroblock (or subblock) from a reference frame or reference field of the video signal to a current frame or field. In operation, the motion search module operates within a search range to locate a macroblock (or subblock) in the current frame or field to an integer pixel level accuracy such as to a resolution of 1-pixel. Candidate locations are evaluated based on a cost formulation to determine the location and corresponding motion vector that have a most favorable (such as lowest) cost.

In an embodiment of the present invention, a cost formulation is based on the Sum of Absolute Difference (SAD) between the reference macroblock and candidate macroblock pixel values and a weighted rate term that represents the number of bits required to be spent on coding the difference between the candidate motion vector and either a predicted motion vector (PMV) that is based on the neighboring macroblock to the right of the current macroblock and on motion vectors from neighboring current macroblocks of a prior row of the video input signal or an estimated predicted motion vector that is determined based on motion vectors from neighboring current macroblocks of a prior row of the video input signal. In an embodiment of the present invention, the cost calculation avoids the use of neighboring subblocks within the current macroblock. In this fashion, motion search module 204 is able to operate on a macroblock to contemporaneously determine the motion search motion vector for each subblock of the macroblock.

A motion refinement module 206 generates a refined motion vector for each macroblock of the plurality of macroblocks, based on the motion search motion vector. In an embodiment of the present invention, the motion refinement module determines, for each macroblock or macroblock pair of a field and/or frame of the video input signal 110, a refined motion vector that represents the displacement of the macroblock from a reference frame or reference field of the video signal to a current frame or field.

Based on the pixels and interpolated pixels, the motion refinement module 206 refines the location of the macroblock in the current frame or field to a greater pixel level accuracy such as to a resolution of ¼-pixel or other sub-pixel resolution. Candidate locations are also evaluated based on a cost formulation to determine the location and refined motion vector that have a most favorable (such as lowest) cost. As in the case with the motion search module, a cost formulation can be based on the a sum of the Sum of Absolute Difference (SAD) between the reference macroblock and candidate macroblock pixel values and a weighted rate term that represents the number of bits required to be spent on coding the difference between the candidate motion vector and either a predicted motion vector (PMV) that is based on the neighboring macroblock to the right of the current macroblock and on motion vectors from neighboring current macroblocks of a prior row of the video input signal or an estimated predicted motion vector that is determined based on motion vectors from neighboring current macroblocks of a prior row of the video input signal. In an embodiment of the present invention, the cost calculation avoids the use of neighboring subblocks within the current macroblock. In this fashion, motion refinement module 206 is able to operate on a macroblock to contemporaneously determine the motion search motion vector for each subblock of the macroblock.

When estimated predicted motion vectors are used, the cost formulation avoids the use of motion vectors from the current row and both the motion search module 204 and the motion refinement module 206 can operate in parallel on an entire row of video input signal 110, to contemporaneously determine the refined motion vector for each macroblock in the row.

A direct mode module 208 generates a direct mode motion vector for each macroblock, based on macroblocks that neighbor the macroblock. In an embodiment of the present invention, the direct mode module 208 operates to determine the direct mode motion vector and the cost associated with the direct mode motion vector based on the cost for candidate direct mode motion vectors for the B slices of video input signal 110, such as in a fashion defined by the H.264 standard.

While the prior modules have focused on inter-prediction of the motion vector, intra-prediction module 210 generates a best intra prediction mode for each macroblock of the plurality of macroblocks. In an embodiment of the present invention, intra-prediction module 210 operates as defined by the H.264 standard, however, other intra-prediction techniques can likewise be employed. In particular, intra-prediction module 210 operates to evaluate a plurality of intra prediction modes such as a Intra-4×4 or Intra-16×16, which are luma prediction modes, chroma prediction (8×8) or other intra coding, based on motion vectors determined from neighboring macroblocks to determine the best intra prediction mode and the associated cost.

A mode decision module 212 determines a final macroblock cost for each macroblock of the plurality of macroblocks based on costs associated with the refined motion vector, the direct mode motion vector, and the best intra prediction mode, and in particular, the method that yields the most favorable (lowest) cost, or an otherwise acceptable cost. A reconstruction module 214 completes the motion compensation by generating residual luma and/or chroma pixel values for each macroblock of the plurality of macroblocks.

A forward transform and quantization module 220 of video encoder/decoder 102 generates processed video signal 112 by transforming coding and quantizing the residual pixel values into quantized transformed coefficients that can be further coded, such as by entropy coding in entropy coding module 216. In an embodiment of the present invention, further formatting and/or buffering can optionally be performed by signal interface 198 and the processed video signal 112 can be represented as being output therefrom.

As discussed above, many of the modules of motion compensation module 150 operate based on motion vectors determined for neighboring macroblocks. Neighbor management module 218 generates and stores neighbor data for at least one macroblock of the plurality of macroblocks for retrieval by at least one of the motion search module 204, the motion refinement module 206, the direct mode module 208, intra-prediction module 210, entropy coding module 216 and deblocking filter module 222, when operating on at least one neighboring macroblock of the plurality of macroblocks. In an embodiment of the present invention, a data structure, such as a linked list, array or one or more registers are used to associate and store neighbor data for each macroblock in a buffer, cache, shared memory or other memory structure for later retrieval.

The motion search module 204 and/or the motion refinement module 206, can generate at least one predicted motion vector (such as a standard PMV or estimated predicted motion vector) for each macroblock of the plurality of macroblocks using retrieved neighbor data. Further, the direct mode module 208 can generate at least one direct mode motion vector for each macroblock of the plurality of macroblocks using retrieved neighbor data and the intra-prediction module 210 can generate the best intra prediction mode for each macroblock of the plurality of macroblocks using retrieved neighbor data, and the coding module 216 can use retrieved neighbor data in entropy coding, each as set forth in the H.264 standard, the MPEG-4 standard, VC-1 (SMPTE standard 421M) or by other standard or other means.

While not expressly shown, video encoder/decoder 102 can include a memory cache, shared memory, a memory management module, and/or other module to support the encoding, decoding or transcoding of video input signal 110 into processed video signal 112.

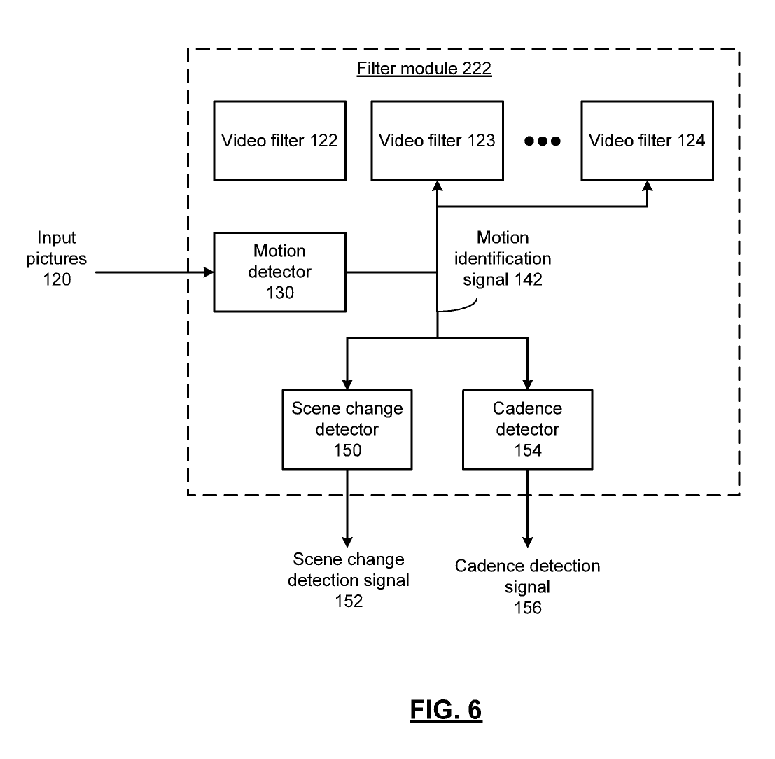

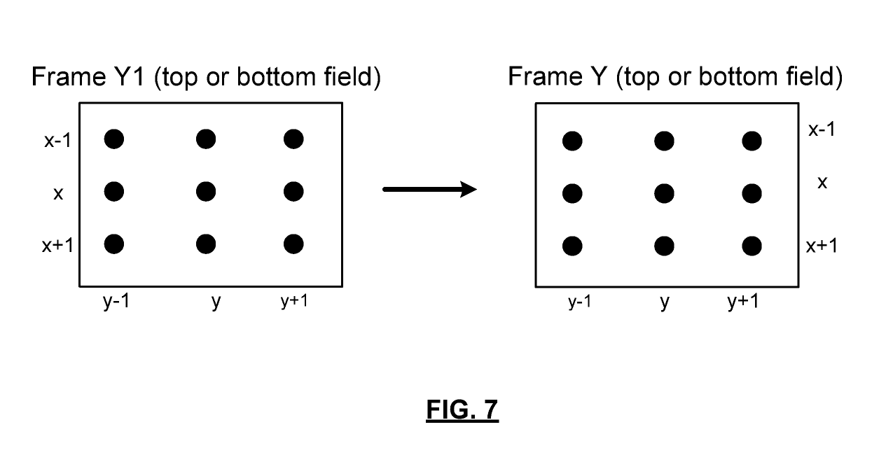

Filter module 222 can include a deblocking filter, a temporal or spatial filter, such as a noise filter, a comb filter or other video filter. In an embodiment of the present invention, the filter module 222 includes a motion detector that generates a motion identification signal that can be used to adapt one or more of the video filters based on motion in the processed video. In addition, the filter module 222 can include a scene change detector and cadence detector for detecting scene changes and the cadence. Further details regarding the operation of filter module 222 will be described in greater detail in conjunction with FIGS. 6 and 7.

FIG. 6 presents a block diagram representation of a filter module 222 in accordance with an embodiment of the present invention. Filter module 222 includes several different video filters 122, 123, 124 . . . used in conjunction with encoding/decoding transcoding or other video processing. While not expressly shown, each of the filters 122, 123, 124 . . . processes a video signal to produce a filtered video signal. For instance, video filter 122 can include a deblocking filter. Video filters 123, 124, etc. can include temporal and/or spatial video filters such as noise filters, comb filters or other filters. In particular, video filters 123, 124 are adapted based on motion identification signal 140 either to be selectively enabled or disabled.

In one example the video filter 124 includes a first filter such as a 2-line, 3-line, 1D, 2D, 3D, 1H, 2H, or other spatial filter that operates to selectively filter a particular pixel. Video filter 123 includes a second filter, such as a comb filter, with temporal filtering and motion compensation or other spatial filtering that is either adaptive to motion in a video signal or otherwise operates in the presence of motion to filter the video signal 110 without undue degradation of picture quality. In one mode of operation, the video filter 124 is selectively enabled or disabled based on the value of the motion identification signal 140. Video filter 123 can respond to the motion identification signal 140 and be enabled when video filter module 124 is disabled.

While the adaptation of filters 123 and 124 is described above in terms of simply enabling or disabling each filter, other adaptations are likewise possible including providing different filter parameters to one or both filters 123 and 124 in either the presence of motion, or based on the amount of motion that is detected. Motion identification signal 140 can indicate an amount of motion on either a pixel by pixel basis, or on a picture by picture basis and can be performed separately for both luma and chroma components.

In an embodiment of the present invention, the motion identification signal 140 is computed for each picture of input pictures 120. The motion in each picture, such as a video field (or frame if it is progressive-scan video source), can be represented by a parameter called Global Motion (GM). The value of GM quantifies the change of the field compared to the previous same-parity field. In terms of each macroblock pair, the top field is compared to the top field, bottom field compared to bottom field, etc. The value of GM can be computed as the sum of Pixel Motion (PM) over all pixels in the field or frame, where the value of PM is calculated for each pixel in the field or frame.

FIG. 7 presents a graphical representation of a pixel matrix from different pictures in accordance with an embodiment of the present invention. In this example, Y represents the current field/frame and Y1 represents the previous field/frame. For any pixel, the 9 pixels of a 3 by 3 block centering on the pixel are used. The motion detection result is given by:

M=Σ|Y[i,j]−Y1[i,j]|

Where [x, y] is the current pel for which motion detection is performed, [i j] are 9 pels around (and including) the current one. In other words, i=(x−1, x, x+1) and j=(y−1, y, y+1).

The value of PM is found by capping the value M to a motion value threshold T. Thus,

If (M<T), PM=M

Else, PM=T

As discussed in conjunction with FIG. 6, the value of GM can be computed as the sum of Pixel Motion (PM) over all pixels in the field or frame.

In addition to its use for motion adaptive filtering, the motion identification signal 140, such as the parameter GM, can also be used to detect cadence in video sequence. In operation, cadence detector 154 stores and analyzes GM for a sequence of input pictures 120. The repeated fields in the sequence of input pictures 120 will generate considerably lower GM values compared to “normal” fields. The cadence in the video sequence can be detected by analyzing consecutive fields and detecting a GM pattern. For example, one such pattern could be lower GM values occurring at a repetition period that can be used to lock on to the frame rate of the original source material. In response, the cadence detection signal 156 can be generated to indicate the particular pattern/cadence that was detected. The cadence detection signal 156 can be used in the encoding, decoding, transcoding or other processing by encoder/decoder 102, for example, to produce an output signal that is synchronized to the original frame rate.

The motion identification signal 140, such as the parameter GM, can be further used to detect a scene change in the input pictures 120. When scene happens on a field, the field will generate considerably higher GM value compared to “normal” fields. A scene change can be detected by analyzing the GM pattern along consecutive fields, for example by detecting an increase or decrease in GM in consecutive fields that exceeds a scene detection threshold.

Once a scene change is detected that corresponds to a particular image, the quality can be rapidly adjusted to compensate. In one example, the encoder/decoder 102 responds to the scene detection signal 152 by adjusting the values of QP to compensate for the scene change. The scene signal 152 can be used to adjust or adapt other parameters of the encoding, decoding, transcoding or other processing by encoder/decoder 102.

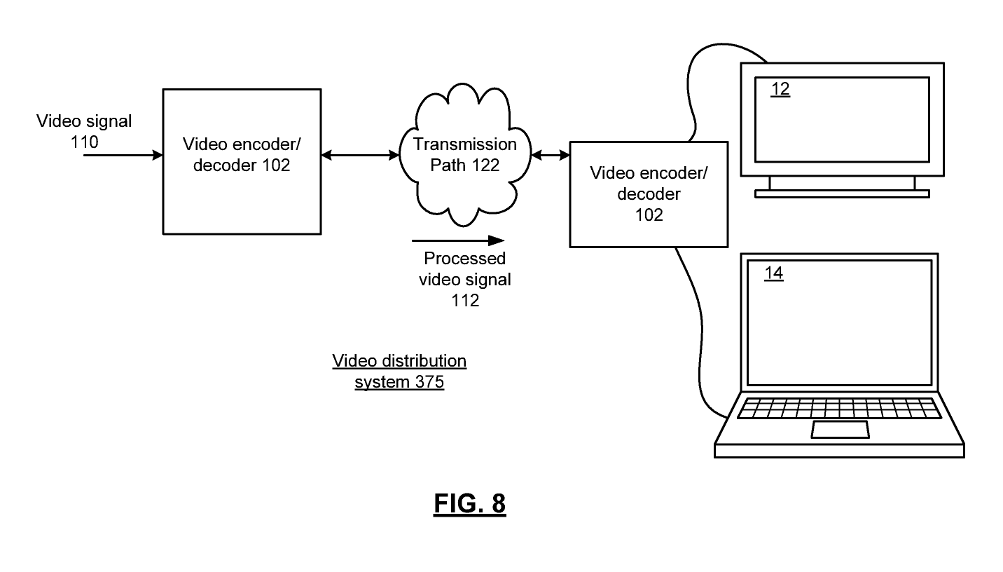

FIG. 8 presents a block diagram representation of a video distribution system 375 in accordance with an embodiment of the present invention. In particular, processed video signal 112 is transmitted from a first video encoder/decoder 102 via a transmission path 122 to a second video encoder/decoder 102 that operates as a decoder. The second video encoder/decoder 102 operates to decode the processed video signal 112 for display on a display device such as television 10, computer 20 or other display device.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a Universal Serial Bus protocol, an Ethernet protocol or other high speed protocol.

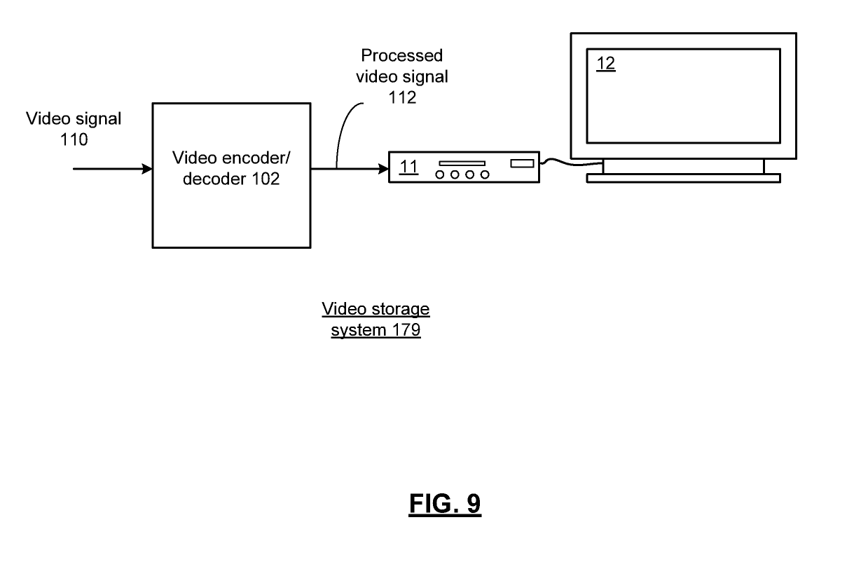

FIG. 9 presents a block diagram representation of a video storage system 179 in accordance with an embodiment of the present invention. In particular, device 11 is a set top box with built-in digital video recorder functionality, a stand alone digital video recorder, a DVD recorder/player or other device that stores the processed video signal 112 for display on video display device such as television 12. While video encoder/decoder 102 is shown as a separate device, it can further be incorporated into device 11. In this configuration, video encoder/decoder 102 can further operate to decode the processed video signal 112 when retrieved from storage to generate a video signal in a format that is suitable for display by video display device 12. While these particular devices are illustrated, video storage system 179 can include a hard drive, flash memory device, computer, DVD burner, or any other device that is capable of generating, storing, decoding and/or displaying the video content of processed video signal 112 in accordance with the methods and systems described in conjunction with the features and functions of the present invention as described herein.

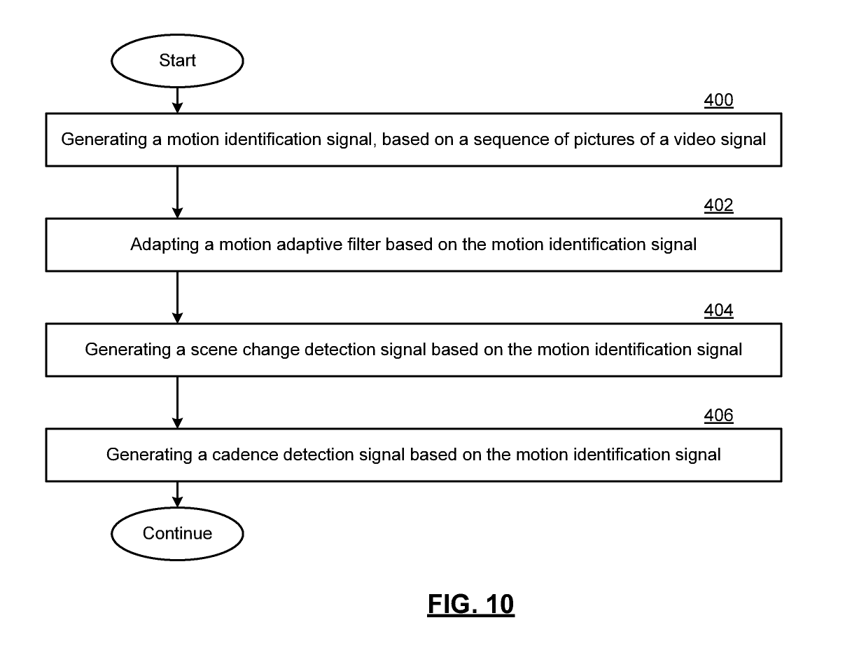

FIG. 10 presents a flowchart representation of a method in accordance with an embodiment of the present invention. In particular, a method is presented for use in conjunction with a video processing device having one or more of the features and functions described in association with FIGS. 1-9. In step 400, a motion identification signal is generated, based on a sequence of pictures of a video signal. In step 402, a motion adaptive filter is adapted based on the motion identification signal. In step 404, a scene change detection signal is generated, based on the motion identification signal. In step 406, generating a cadence detection signal, based on the motion identification signal.

In an embodiment of the present invention, step 400 includes generating the pixel motion for a current pixel by analyzing a block of pixels that include the current pixel, and summing the pixel motion for all pixels in a picture. Analyzing the block of pixels can include generating a motion value based on a sum of absolute difference between a value of each pixel in the block of pixels and a value of a corresponding pixel of a corresponding block of pixels in a prior picture in the sequence of pictures; comparing the motion value to a motion value threshold; generating the pixel motion as the motion value when the motion value compares favorably to the motion value threshold; and generating the pixel motion as the motion value threshold when the motion value compares unfavorably to the motion value threshold.

In an embodiment of the present invention, step 406 includes detecting a pattern in the motion identification signal for the sequence of pictures; and generating the cadence detection signal to indicate a cadence value when the pattern in the motion identification signal is detected. Step 404 can include generating a motion difference between consecutive pictures based on the motion identification signal; comparing the a motion difference to a scene change threshold; and generating the scene change detection signal to indicate a scene change when the motion difference compares unfavorably to the scene change threshold.

In preferred embodiments, the various circuit components are implemented using 0.35 micron or smaller CMOS technology. Provided however that other circuit technologies, both integrated or non-integrated, may be used within the broad scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a video encoder/decoder. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A filter for use in conjunction with a video processing device, the filter comprising:
at least one motion adaptive filter for processing a video signal, based on a motion identification signal;
a motion detector, coupled to the at least one motion adaptive filter, that generates the motion identification signal, based on a sequence of pictures of the video signal; and
a scene change detector, coupled to the motion detector, that generates a scene change detection signal, based on the motion identification signal.

2. The filter of claim 1, wherein the motion detection module generates the motion identification signal by:
summing a pixel motion for all pixels in a picture.

3. The filter of claim 2, wherein the motion detection module generates the pixel motion for a current pixel by analyzing a block of pixels that include the current pixel.

4. The filter of claim 3, wherein the motion detection module analyzes the block of pixels that include the current pixel by:
generating a motion value based on a sum of absolute difference between a value of each pixel in the block of pixels and a value of a corresponding pixel of a corresponding block of pixels in a prior picture in the sequence of pictures.

5. The filter of claim 4, wherein the motion detection module analyzes the block of pixels that include the current pixel by further:
comparing the motion value to a motion value threshold;
generating the pixel motion as the motion value when the motion value compares favorably to the motion value threshold; and
generating the pixel motion as the motion value threshold when the motion value compares unfavorably to the motion value threshold.

6. The filter of claim 1, further comprising;
a cadence detector, coupled to the motion detector, that generates a cadence detection signal, based on the motion identification signal.

7. The filter of claim 6, wherein the cadence detector detects a pattern in the motion identification signal for the sequence of pictures, and generates the cadence detection signal to indicate a cadence value when the pattern in the motion identification signal is detected.

8. The filter of claim 1, wherein the scene change detector generates a motion difference between consecutive pictures based on the motion identification signal, compares the motion difference to a scene change threshold and generates the scene change detection signal to indicate a scene change when the motion difference compares unfavorably to the scene change threshold.

9. A method for use in conjunction with a video processing device, the method comprising:
generating a motion identification signal, based on a sequence of pictures of a video signal;
adapting a motion adaptive filter based on the motion identification signal; and
generating a scene change detection signal, based on the motion identification signal.

10. The method of claim 9, wherein generating the motion identification signal includes:
summing a pixel motion for all pixels in a picture.

11. The method of claim 10, further comprising:
generating the pixel motion for a current pixel by analyzing a block of pixels that include the current pixel.

12. The method of claim 11, wherein analyzing the block of pixels includes:
generating a motion value based on a sum of absolute difference between a value of each pixel in the block of pixels and a value of a corresponding pixel of a corresponding block of pixels in a prior picture in the sequence of pictures.

13. The method of claim 12, wherein analyzing the block of pixels further includes:
comparing the motion value to a motion value threshold;
generating the pixel motion as the motion value when the motion value compares favorably to the motion value threshold; and
generating the pixel motion as the motion value threshold when the motion value compares unfavorably to the motion value threshold.

14. The method of claim 9, further comprising;
generating a cadence detection signal, based on the motion identification signal.

15. The method of claim 14, wherein generating the cadence detection signal includes:
detecting a pattern in the motion identification signal for the sequence of pictures; and
generating the cadence detection signal to indicate a cadence value when the pattern in the motion identification signal is detected.

16. The method of claim 9, wherein generating the scene change detection signal includes:
generating a motion difference between consecutive pictures based on the motion identification signal;
comparing the a motion difference to a scene change threshold; and
generating the scene change detection signal to indicate a scene change when the motion difference compares unfavorably to the scene change threshold.
